(19) United States
(12) Patent Application Publication
(10) Pub. No.: US 2022/0225633 A1
(43) Pub. Date: Jul. 21, 2022

(54) FAT COMPOSITIONS COMPRISING Sat2O TRIGLYCERIDES

(71) Applicant: AAK AB (PUBL), Malmö (DK)

(72) Inventor: Bjarne JUUL, Højbjerg (DK)

(21) Appl. No.: 17/435,463

(22) PCT Filed: Mar. 5, 2020
(86) PCT No.: PCT/EP2020/055905

§ 371 Date: Sep. 1, 2021

(30) Foreign Application Priority Data
Mar. 6, 2019 (SE) 1950284-8

(51) Int. Cl. A23G 1/38; A23G 1/30; A23G 3/34; A23G 3/40; A23D 9/00

(52) U.S. Cl. CPC A23G 1/38; A23G 1/305; A23V 2002/00; A23G 3/40; A23D 9/00; A23G 3/343

(57) ABSTRACT

The present invention relates to a fat composition comprising triglycerides of which at least 75% is of the type Sat₂O, and wherein in the fat composition: a) the content of St₂O is 30% or less of the total fat, and b) the ratio (StOSt+StStO)/(POSt+PStO+StPO) is at least 0.95. The invention also relates to uses of the fat composition and to a coating compound, chocolate or chocolate-like product comprising the fat composition according to the present invention.

### TECHNICAL FIELD OF THE INVENTION

The present disclosure relates to a fat composition comprising triglycerides of which at least 75% is of the type Sat₂O. The invention also relates to uses of the fat composition and to a coating compound or chocolate or chocolate-like product comprising a fat composition according to the present disclosure.

### BACKGROUND OF THE INVENTION

When manufacturing confectionary products e.g. chocolate or chocolate-like products it is highly important to produce a product with good bloom stability, good form stability, while at the same time maintaining the characteristic chocolate melting and taste.

In confectionary products cocoa butter (CB) and cocoa butter equivalents (CBEs) are well known ingredients. The production of CBEs is based on fractions of fats containing the same triglycerides as CB, e.g. palm oil, shea butter, illipe, etc. The main part of the triglycerides is of the symmetric SatUSat type (Sat=saturated fatty acids, U=unsaturated fatty acids) or more specifically, StOSt, POSt and POP (P=palmitic acid (C16:0), St=stearic acid (C18:0), O=oleic acid (C18:1)).

Cocoa butter (CB) and cocoa butter equivalents (CBEs) consist of approximately 75-85% Sat₂O triglycerides (both symmetrical and asymmetrical) measured with the official AOCS method Ce 5b-89 (The American Oil Chemists' society; Triglycerides in Vegetable Oils by HPLC), most often it consist of between 77% and 83% Sat₂O triglycerides.

The method AOCS Ce 5b-89 is a “relative” method which covers measurements on C44-C56 triglycerides (TAGs). The AOCS method does not take into account any impurities because the calculations in the method assumes that the total sum of the peak areas corresponds to 100% triglycerides. The formula used in this method is the following:

% triglyceride=(area of peak/Sum of all peak)×100

The sensory, texture, melting profile, contraction, tempering behaviour, bloom stability, and heat stability of a chocolate or chocolate-like product is closely related to a variety of properties of the fat, i.e. the 75-85% Sat₂O TAGs and the ratio between the three TAGs—POP, POSt, and StOSt; and their isomers.

There is some variation in cocoa butter in its ratio between the different Sat₂O TAGs, but the content of POSt is the highest, followed by StOSt and POP is the lowest.

A standard cocoa butter has a Sat₂O composition as shown in table 1.

TABLE 1

| TAG content of cocoa butter | % |
|---|---|
| POP | 13-16 |
| POSt | 36-39 |
| StOSt | 26-30 |

Cocoa butter equivalents are normally used to exchange part of the cocoa butter in a chocolate recipe. By doing so beneficial characteristics can be achieved which cannot be achieved using only cocoa butter (CB), e.g. increased bloom stability. A number of standard CBEs already exists on the market.

It is known that heat resistance and a higher melting point are followed by a more waxy taste and are closely connected to a higher content of StOSt TAGs. This relation is used in the industry by adding StOSt TAGs from different raw materials like shea stearin or Sal stearin to the chocolate. A higher content of StOSt will also make the chocolate more bloom stabile at elevated temperatures.

Ghazani et al (Cryst. Growth Des. 2019, 19, 90-97; The Triclinic Polymorphism of cocoa butter Is Dictated by Its Major Molecular Species, 1-Palmitoyl, 2-Oleoyl, 3-Stearoyl Glycerol (POS)) show a possible relationship between a polymorphic transition in POS and the transformation from form V (the solid state transition from the crystal in chocolate) to form VI in cocoa butter, form VI is associated with blooming.

Minor additions of interesterified compositions containing long and short chain fatty acids is known and used as bloom inhibiting fats in chocolate as taught in EP0530864B1 and PCT/DK02/00728, but with the disadvantages being eutectic effect, risk of soapy taste, and labelling of hydrogenation of the resulting product.

Addition of asymmetric TAGs is known to have a bloom retarding effect on chocolate (PCT/DK2005/000647).

From the above mentioned, it appears that there is a need for fat compositions that keeps recognizable cocoa butter melting profile, has no waxy taste, and has good bloom stability. It is preferable that the bloom stability is present over a wide temperature range so that the resulting chocolate does not bloom, i.e. bloom resistance is achieved both at higher storage temperatures than normal and lower storage temperatures than normal.

Accordingly, the main object of the invention is to provide fat compositions providing good bloom stability at elevated temperatures. Further, the fat composition should have good sensory aspects such as no waxy taste.

Another object is to provide fat compositions, which show good bloom stability at elevated temperatures with no waxy taste in a final confectionery product.

### SUMMARY OF THE INVENTION

The present invention relates to a fat composition comprising triglycerides of which at least 75% is of the type Sat₂O, and wherein in the fat composition:
a) the content of St₂O is 30% or less of the total fat, and
b) the ratio (StOSt+StStO)/(POSt+PStO+StPO) is at least 0.95.

This invention cover a defined area of fat compositions, which are based on the same Sat₂O TAGs as found in a chocolate based on cocoa butter and/or CBEs, but their ratios between the individual TAGs is very special compared to the ratio in the composition in a standard chocolate.

The inventors have shown that the content of St₂O (that is StOSt and StStO) TAGs has to be close to or lower than the St₂O content as found in a standard chocolate composition to ensure the same nice and fast melting, but at the same time the ratio between StOSt/POSt (and their isomers) has to be much higher to improve the bloom stability at elevated temperature and still keep the nice melting as found by using a standard cocoa butter.

The above defined bloom stable and well melting fat composition can be defined as having a content of Sat₂O TAGs of at least 75%, a St₂O content of 30% or less, and a ratio of (StOSt+StStO)/(POSt+PStO+StPO) at 0.95 or higher, such as in the range of 1 to 3.

As can be seen from the disclosure, when talking about StOSt content it also covers its isomer StStO, and when talking about (POSt+PStO+StPO) in the above ratio it is all the isomers of POSt. Hence when referring to the short form of the ratio StOSt/POSt in the text it is meant to cover (StOSt+StStO)/(POSt+PStO+StPO)—that is all of their isomers.

The fat composition can be reached in many different ways depending on the cocoa butter origin, content, and additions of different cocoa butter equivalents and dosages and can be made using different sources of triglycerides. The fat composition comprises at least a POP source, a POSt source and a StOSt source. The origin of these triglycerides can be either naturally occurring or they can be synthetically made.

In a standard CB the content of St₂O is also 30% or below, but then the ratio StOSt/POSt is way below 0.95 (around 0.7-0.8). In a standard CBE a ratio above 1 may be observed, however, such CBE will not have an amount of St₂O below 30%.

Both characteristics should be fulfilled to achieve the technical effect. If just the amount of St₂O is increased, then the melting characteristics are changed, and a waxy taste and feeling will occur as described above. A chocolate, or chocolate-like product with this novel special well-defined fat composition and benefits also comprises chocolates or chocolate-like products with up to 20 wt % milk fat of total fat content, such as up to 10 wt % milk fat of total fat content.

It is surprising that it is possible to develop a fat composition that has such good sensory aspects along with the bloom inhibiting effect as supported by the examples.

It is also surprising that it is possible to develop a fat composition that provides improved bloom stability at elevated temperatures and further has good sensory aspects such as no waxy taste.

The present invention further relates to use of the fat composition for the manufacture of a processed food product for human consumption.

The present invention also relates to use of the fat composition as a fat component, which are to be incorporated in a food product for human consumption.

Use of the fat composition as an ingredient in a confectionary product or as an ingredient in a chocolate or chocolate-like product or as an ingredient in coating compounds for a confectionary product is also disclosed herein.

The invention also relates to a coating compound, chocolate, or chocolate-like product comprising 15-60%, such as 20-50%, by weight of a fat composition according to the present disclosure.

It is surprising that it is possible to manufacture a coating compound, chocolate, or chocolate-like product comprising the fat composition disclosed herein, which show improved bloom stability at elevated temperatures with no waxy taste.

### Definitions

In the context of the present invention, the following terms are meant to comprise the following, unless defined elsewhere in the description.

The terms “about”, “around”, or “approximately” are meant to indicate e.g. the measuring uncertainty commonly experienced in the art, which can be in the order of magnitude of e.g. +/−1, 2, 5, 10%, etc.

The term “comprising” or “to comprise” is to be interpreted as specifying the presence of the stated parts, steps, features, or components, but does not exclude the presence of one or more additional parts, steps, features, or components.

As used herein, “vegetable oil” and “vegetable fat” is used interchangeably, unless otherwise specified. As used herein, the term “vegetable” shall be understood as originating from a plant retaining its original chemical structure/composition. Thus, a vegetable fat or vegetable triglycerides are still to be understood as vegetable fat or vegetable triglycerides after fractionation etc. as long as the chemical structure of the fat components or the triglycerides are not altered. When vegetable triglycerides are for example transesterified they are no longer to be understood as a vegetable triglyceride in the present context.

Similarly, the term “non-vegetable” in the context of “non-vegetable triglyceride” or “non-vegetable fat” when used herein is intended to mean obtained from other sources than native vegetable oils or fractions thereof, or obtained after transesterification. Examples of non-vegetable triglycerides may for example be, but are not limited to, triglycerides obtained from animal fat, and/or transesterification.

As used herein the term “single cell oil” shall mean oil from oleaginous microorganisms, which are species of yeasts, molds (fungal), bacteria, or microalgae. These single cell oils are produced intracellular in the stationary growth phase under specific growth conditions (e.g. under nitrogen limitation with simultaneous excess of a carbon source). Examples of oleaginous microorganisms are, but not limited to; fungi—Mucor and Mortierella (various species, e.g. M. alpina); oleaginous yeast—Yarrowia lipolytica; Algea—Schizochytrium, Nannochloropsis, Chlorella (various species); Dinoflagellate microalgae—Crypthecodinium cohnii; Marine bacteria—Shewanella.

As used herein, the term “triglycerides” may be used interchangeably with the term “triacylglycerides” and should be understood as an ester derived from glycerol and three fatty acids. “Triglycerides” may be abbreviated TG or TAG. A single triglyceride molecule, having a specific molecular formula, is of either vegetable or non-vegetable origin. Some triglycerides, like for example StOSt-triglycerides, may be obtained from both vegetable and/or non-vegetable sources. Thus, a fat phase comprising StOSt-triglycerides, may comprise StOSt-triglycerides obtained solely from vegetable sources, or StOSt-triglycerides obtained solely from non-vegetable sources, or a combination thereof, i.e. said fat phase may comprise some StOSt-triglyceride molecules obtained from vegetable sources and some StOSt-triglycerides molecules obtained from non-vegetable sources.

By fat composition is meant the total fat content of a chocolate or a chocolate-like product or of a coating compound, which may include vegetable fat, cocoa butter coming from cocoa biomass (e.g. cocoa powder, cocoa liquor), and may also comprise milk fat and other sources of fat. By fat composition may also be meant the total fat content of a confectionary product such as a solid bar or a coating. Hence by total fat content of a confectionary product is meant a confectionary product without a filling (i.e. the filling fat is excluded from the total fat calculation if the confectionary product contains a filling).

As used herein “edible” is something that is suitable for use as food or as part of a food product, such as a dairy or confectionary product. An edible fat is thus suitable for use as fat in food or food product and an edible composition is a composition suitable for use in food or a food product, such as a dairy or confectionary product.

The % amount of a triglyceride (TAG) is determined using the AOCS Ce 5b-89 method which is a standard method for determining triglycerides in vegetable oils by HPLC. So when measuring triglycerides, % is meant the relative value (not wt % or % by weight) when having one value which is a smaller part of another value and the relative contribution is intended to be described. The asymmetric isomers are included in the amount specified under each TAGs in the examples since the method used (AOCS Ce 5b-89) does not measure the difference in isomeric state of a TAG and therefore does not take into account the different isomers of a given TAG. Hence, for example, when there is written POSt in the tables herein it also includes its isomers: PStO and StPO.

As used herein a “chocolate” is to be understood as a chocolate and/or chocolate-like product. Some chocolate comprises cocoa butter, typically in substantial amounts, where some chocolate-like products may be produced with a low amount of or even without cocoa butter, e.g. by replacing the cocoa butter with a cocoa butter equivalent, cocoa butter substitute, etc. Also, many chocolate products comprise cocoa powder or cocoa mass, although some chocolate products, such as typical white chocolates, may be produced without cocoa powder, but e.g. drawing its chocolate taste from cocoa butter. Depending on the country and/or region there may be various restrictions on which products may be marketed as chocolate. By a chocolate product is meant a product, which at least is experienced by the consumer as chocolate or as a confectionery product having sensorial attributes common with chocolate, such as e.g. melting profile, taste etc.

The chocolate can also be a chocolate comprising milk fat, however without being labelled as “milk chocolate”. The European legislation states that in order for a chocolate to be labelled as a milk chocolate it should comprise a minimum of 3.5 wt % milk fat of the total chocolate recipe which corresponds to 7-14 wt % of a standard chocolate's fat composition depending of fat content.

As used herein “cocoa butter equivalent” or CBE is intended to mean an edible fat having very similar chemical and physical properties and being compatible with cocoa butter. In both cocoa butter and cocoa butter equivalent the main fatty acids are typically palmitic, stearic, and oleic acids. The triglycerides are typically 2-oleo di-saturated (SatOSat (Sat₂O)). In spite of their similarity to cocoa butter, cocoa butter equivalents can be detected in chocolate by their triglyceride ratios, which are appreciably different from those in cocoa butter. Cocoa butter equivalents are e.g. made from a mix of palm mid fraction and a fractionated part of shea stearin or another oil fraction rich in SatOSat triglycerides, where Sat is a saturated fatty acid having a chain length of C16 or longer, such as C16 and C18.

For saturated fatty acid the abbreviation SAFA is used, and for trans-unsaturated fatty acids the abbreviation TFA is used.

S or Sat means a saturated fatty acid/acyl-group, and U means an unsaturated fatty acid/acyl group. The fatty acids, which are comprised in the triglycerides of formulae SSU, SUS, etc. and referred to in the SSU/SUS ratio, may be identical or different, saturated and unsaturated fatty acids. St means stearic acid/stearate (C18:0), 0 means oleic acid/oleate (C:18:1), P means Palmitic acid (C16:0), St₂O includes StOSt and StStO, and Sat₂O includes POP, POSt, StOSt, PPO, PStO, StPO and StStO.

As used herein a “heat stable chocolate” is a chocolate which has a relatively high resistance to heat and heat-related effects, particularly bloom and form stability. The heat stable chocolate will in certain embodiments retain this heat stability, particularly bloom stability, at temperatures above where such stability is normally lost for conventional chocolate products.

In this context, the term “bloom resistance” refers to a property of the chocolate to resist bloom formation. Increased or improved bloom resistance in a chocolate in the present context thus implies that the chocolate has a higher resistance towards blooming which can be observed as a white/grey fat layer on the surface.

### BRIEF DESCRIPTION OF THE DRAWING

The invention is further illustrated by the drawings, wherein

FIG. 1a: Illustrates the relation between the StOSt/POSt ratio and bloom stability for dark chocolate.

FIG. 1b: Illustrates the relation between BCI value and bloom stability for dark chocolate.

FIG. 1c: Illustrates the relation between the BCI value and the ratio between StOSt/POSt.

### DETAILED DESCRIPTION OF THE INVENTION

Disclosed herein is a fat composition comprising triglycerides of which at least 75% is of the type Sat₂O, and wherein in the fat composition:
a) the content of St₂O is 30% or less of the total fat, and
b) the ratio (StOSt+StStO)/(POSt+PStO+StPO) is at least 0.95.

In one embodiment between 75% and 85% of said triglycerides is of the type Sat₂O. In another embodiment between 77% and 83% of said triglycerides is of the type Sat₂O.

The content of St₂O is 29% or less of the total fat content in one embodiment. The content of St₂O is 28% or less of the total fat content in one embodiment.

The content of St₂O is in one embodiment between 8% and 30%, such as between 10% and 28%.

In one embodiment the ratio (StOSt+StStO)/(POSt+PStO+StPO) is at least 1. In another embodiment the ratio (StOSt+StStO)/(POSt+PStO+StPO) is between 1 and 3.

The content of St₂O TAGs has to be close to or lower than the St₂O content as found in a standard chocolate composition to ensure the same nice and fast melting, but at the same time the ratio between StOSt/POSt has to be much higher to improve the bloom stability at elevated temperature and still keep the nice melting as found by using a standard cocoa butter.

The above defined bloom stable well melting fat composition can be defined as having a content of Sat₂O TAGs higher than 75% and a St₂O content less than 30% and a ratio between (StOSt+StStO)/(POSt+PStO+StPO) at 0.95 or higher, such as in the range of 1 to 3.

From the examples it is shown that for a chocolate or chocolate-like product with a maximum of 30% St₂O TAGs it can be observed and concluded that increasing the ratio of StOSt/POSt increases bloom stability of a dark chocolate stored at 25° C. isotherm.

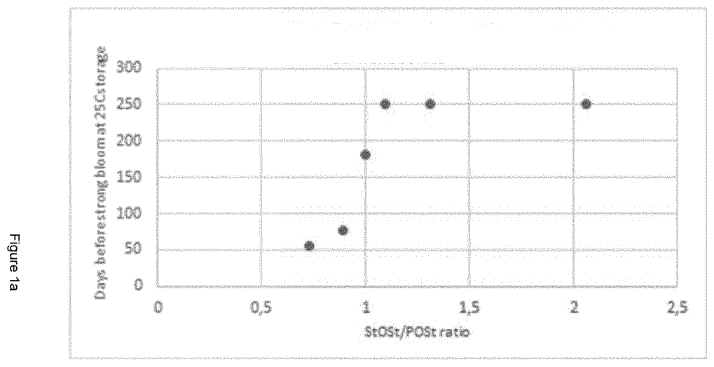

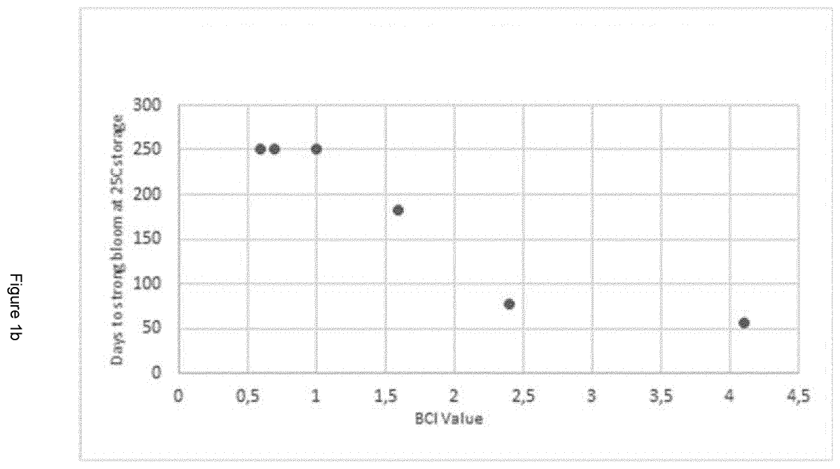

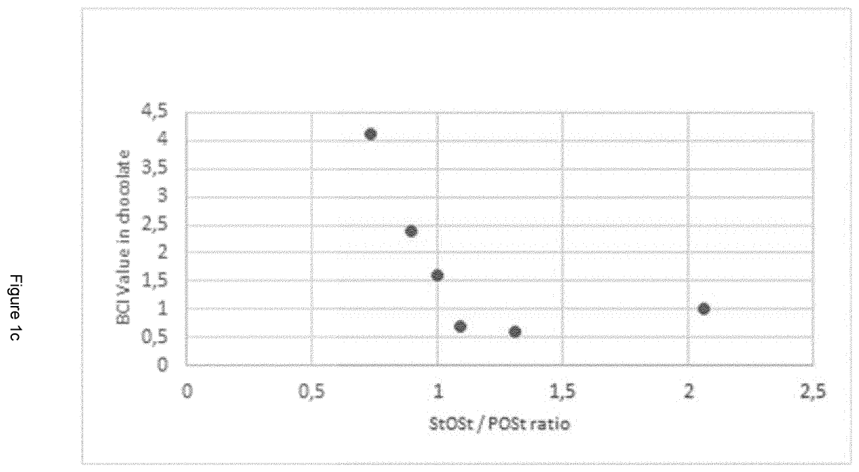

FIG. 1a shows that the ratio between StOSt/POSt is very important for a chocolates bloom stability at an elevate temperature, and it can be concluded that a ratio between StOSt/POSt above 0.95 improves the bloom stability significant.

In one embodiment the content in % of triglycerides of the fat composition can be measured according to the AOCS Ce 5b-89 standard method.

In one embodiment the fat composition does not comprise any milk fat.

The fat composition can in one embodiment further comprise milk fat. In one embodiment the content of milk fat is 20 wt % or less of the total fat content, such as 15 wt % or less of the total fat content, such as 10 wt % or less of the total fat content. In one embodiment the content of milk fat is between 0 and 20 wt % of the total fat content, such as between 0 and 15 wt % of the total fat content, such as between 0 and 10 wt % of the total fat content, such as between 0 and 5 wt % of the total fat content.

In one embodiment the fat composition is a chocolate or chocolate-like fat composition. In another embodiment the fat composition is a coating compound.

Further disclosed is the use of the fat composition as disclosed herein for the manufacture of a processed food product for human consumption.

Further disclosed is also the use of the fat composition as disclosed herein, which are to be incorporated in a food products for human consumption.

Further disclosed is also the use of the fat composition as disclosed herein as an ingredient in a confectionary product.

Further disclosed is also the use of the fat composition as disclosed herein as an ingredient in coating compounds for a confectionary product. The coating compounds will typically comprise between 15% and 60% by weight of a fat composition, such as between 20% and 50% by weight of a fat composition.

Further disclosed is also the use of the fat composition as disclosed herein as an ingredient in a chocolate or chocolate-like product. The chocolate or chocolate-like product will typically comprise between 15% and 60% by weight of a fat composition, such as between 20% and 50% by weight of a fat composition.

Further disclosed is also a coating compound, chocolate or chocolate-like product comprising between 15% and 60% by weight of a fat composition, such as between 20% and 50% by weight of a fat composition, as disclosed herein.

### EXAMPLES

In the examples, 25° C. isothermal storage are used as a representative temperature since this is a common storage temperature in most countries during at least summer time. However, the chocolate industry also has problems at 23° C. and 27° C.—any elevated temperature above room temperature (19-21° C.) will accelerate bloom development, and the shelf life drops significantly.

### Example 1

Bloom formation is one standard parameter to evaluate the quality of a chocolate. Bloom forms during storage of chocolate, and this formation is accelerated with increasing storage temperature. At room temperature, 19° C. to 21° C., the shelf life (i.e. the time before bloom is formed) for a dark well processed chocolate is more than a year, while it will be reduced to 1.5-3 months if it is kept at a 25° C. isothermal storage.

It is desired to avoid strong bloom formation, because the consumer reacts by rejecting the product with bloom as a poor product of inferior quality. Temperature at 25° C. is in many countries a quite common temperature in summertime, and therefore an improvement on bloom stability at that temperature makes a significant improvement for the market. For that reason all examples are evaluated at 25° C.+/−0.5° C. of a trained panel of experts. The days before strong visible bloom is formed is noted in the results for shelf life in the following examples.

Six different fat compositions are made by mixing cocoa butter, shea stearin and a PMF IV 33 (Palm Mid Fraction) to a certain triglyceride composition comprising at least a StOSt source, a POP source and a POSt source. Fat composition I is standard cocoa butter and thus a reference fat. The six different fat compositions are used to produce six different chocolates by using the recipe in table 2.

TABLE 2

| | Chocolate | | | | | |
|---|---|---|---|---|---|---|
| All amounts are in wt % | I | II | II | IV | V | VI |
| Sugar | 48.58 | 48.58 | 48.58 | 48.58 | 48.58 | 48.58 |
| Cocoa powder (11%) | 15.00 | 15.00 | 15.00 | 15.00 | 15.00 | 15.00 |
| Skim milk powder | 6.00 | 6.00 | 6.00 | 6.00 | 6.00 | 6.00 |
| Lecithin | 0.40 | 0.40 | 0.40 | 0.40 | 0.40 | 0.40 |
| Vanillin | 0.02 | 0.02 | 0.02 | 0.02 | 0.02 | 0.02 |
| Fat I | 30.00 | | | | | |
| Fat II | | 30.00 | | | | |
| Fat III | | | 30.00 | | | |
| Fat IV | | | | 30.00 | | |
| Fat V | | | | | 30.00 | |
| Fat VI | | | | | | 30.00 |
| Total fat content * | 31.65 | 31.65 | 31.65 | 31.65 | 31.65 | 31.65 |

*Note:
Some of the fat content in the fat composition is from cocoa powder.

After mixing all ingredients except lecithin, vanillin and some of the fat, the rest are mixed on a Teddy mixer with heat jacket to a consistence of marcipan. Every mixture are refined afterward on a three rolls Bühler refiner to an average particle size at 20 micron. All six masses are dry chonced for 3 hours before the remaining fat is added and then followed by a wet chonching for 3 hours. 0.5 hours before chonching is finished, lecithin and flavor are added. The chocolate are filled into an Aasted automatical tempering machine and tempering is optimized for all six chocolates to a well temper chocolate before 100 g chocolate bars are made by depositing the well temper chocolate into preheated moulds and cooled in a Blumen three zones cooling tunnel for 30 minutes. Temperatures are adjusted to 15° C. in zone 1 and 3 and 12° C. in zone 2. The de-molded chocolate tablet are kept at 20° C. for a week and then moved to 25° C. cabinet for isothermal storage. Every week the tablet is evaluated for visible bloom by a trained panel of experts and when strong visible bloom is evaluated, the number of days are noted down as the shelf life results. A 100 g tablet is sent for analysis. All fat is extract (using the method AOAC 920.39(4.5.01)) and analysis for the triglyceride composition are made using the AOCS Ce 5b-89 method.

Table 3 shows the content of the different Sat₂O TAGs found by using the method AOCS Ce 5b-89 and the compared shelf life of the chocolate tablets from table 2. The asymmetric isomers are included in the amount specified under each TAGs in the examples since the method used (AOCS Ce 5b-89) does not measure the difference in isomeric state of a TAG. Hence, for example, when there is written POSt in the tables it also includes its isomers; PStO and StPO.

TABLE 3

| | Chocolate | | | | | |
|---|---|---|---|---|---|---|
| | I | II | III | IV | V | VI |
| POP AOCS Ce 5b-89 | 15.1% | *** 22.6% | 29.7% | 50.1% | *** 31.5% | 38.4% |
| POSt AOCS Ce 5b-89 | 38.2% | 30.4% | 24.9% | 14.1% | 20.6% | 12.9% |
| StOSt AOCS Ce 5b.89 | 27.8% | 27.1% | 25.1% | 15.3% | 26.9% | 26.6% |
| Total Sat₂O TAGs | 81.1% | 80.1% | 79.7% | 79.5% | 79.0% | 77.9% |
| Days before strong | >365 | >365 | >365 | >365 | >365 | >365 |
| bloom at 20° C. | | | | | | |
| isothermal storage | | | | | | |
| Days before strong | 196 | >365 | >365 | >365 | >365 | >365 |
| bloom at 23° C. | | | | | | |
| isothermal storage | | | | | | |
| Days before strong | 56 | 77 | 182 | >280 | >280 | >280 |
| bloom at 25° C. | | | | | | |
| isothermal storage | | | | | | |
| StOSt/POSt AOCS Ce 5b-89 | 0.73 | 0.89 | 1.01 | 1.09 | 1.31 | 2.06 |
| BCI value** | 4.1 | 2.4 | 1.6 | 0.7 | 0.6 | 1.0 |

**Note:
BCI value = Bühler Crystallization Index. The method is described of the Company Bühler who produce the instrument.

The BCI value is used in the chocolate and fat industry to predict the crystallization behaviour of cocoa butter in a fast way. It is an empirical value, and a BCI value of above 4 is widely accepted as a good quality cocoa butter regarding crystallization behaviour. Thus, it is an empirical value known in the art.

Results in FIG. 1a, b, and c show a close connection between bloom stability at 25° C., BCI value, and the ratio StOSt/POSt for the fat compositions.

FIG. 1b shows surprisingly that a low BCI value define that a fat composition shows the highest bloom stability at elevate temperature, which are the opposite of the common understanding of BCI value where a high BCI value indicates a better quality. Perhaps this is true regarding crystallization, but clearly not regarding bloom at 25° C. where it seems that a BCI value below 1.6 is preferred (see FIG. 1b).

Chocolate I is a standard chocolate based on 100% cocoa butter (reference) and it is evident that the fat composition of Chocolate I blooms fast in a 25° C. isotherm storage cabinet and get strong bloom after just 56 days, which in many applications are too short shelf life.

For a chocolate with a maximum of 30% St₂O TAGs it can be observed and concluded that increasing ratio of StOSt/POSt increases bloom stability of a dark chocolate stored at 25° C. isotherm.

FIG. 1a shows that the ratio StOSt/POSt is very important for a chocolates bloom stability at an elevate temperature and it can be concluded that a ratio StOSt/POSt above 0.95 improves the bloom stability significant.

FIG. 2a shows a correlation between a chocolates BCI value and bloom stability at 25° C. isotherm. Low BCI value makes much longer bloom stability at 25° C. than a high BCI value, and in the interval between 1 and 2 in BCI value it changes from low bloom stability to high bloom stability for a chocolate with maximum 30% StOSt (and isomers) TAGs of its total Sat₂O Tags.

FIG. 1c shows a close connection between the StOSt/POSt ratio and the BCI value for a certain fat composition. If the StOSt/POSt ratio is below 1.1, the BCI value will increase significant, which indicate a much faster crystallization and thereby a correlation to bloom formation. Above 1.1 the BCI value is mostly constant for all fat composition according to the present invention.

### Example 2

The content of the asymmetric isomers, StStO, PStO/StPO and PPO, will at a certain concentration impact bloom formation in a chocolate or chocolate-like compound. These asymmetric isomers are included in the amount specified under each TAGs in the examples since the method used (AOCS Ce 5b-89) does not measure the difference in isomeric state of a TAG.

Example 2 shows for a constant concentration of these isomers how the (StOSt+StStO)/(POSt+PStO+StPO) ratio surprisingly still have a major impact on bloom stability for a chocolate bar stored at 25° C.+/−0.5° C. isotherm, which is irrespective of the presence of the isomers, hence the example shows that if you keep the asymmetric TAGs constant then the relationship between (StOSt+StStO) and (POSt+PStO+StPO) has an effect on bloom stability.

Five different fat compositions are made by mixing cocoa butter, shea stearin and PMF IV 33 (Palm Mid Fraction) to a certain triglyceride composition comprising at least a StOSt source, a POP source and a POSt source.

The five different fat compositions are used to produce five different chocolates by using the recipe in table 4.

TABLE 4

| All amounts | Chocolate | | | | |
|---|---|---|---|---|---|
| are in wt % | VII | VIII | IX | X | XI |
| Sugar | 48.58 | 48.58 | 48.58 | 48.58 | 48.58 |
| Cocoa powder (11%) | 15.00 | 15.00 | 15.00 | 15.00 | 15.00 |
| Skim milk powder | 6.00 | 6.00 | 6.00 | 6.00 | 6.00 |
| Lecithin | 0.40 | 0.40 | 0.40 | 0.40 | 0.40 |
| Vanillin | 0.02 | 0.02 | 0.02 | 0.02 | 0.02 |
| Fat VII | 30.00 | | | | |
| Fat VIII | | 30.00 | | | |
| Fat IX | | | 30.00 | | |
| Fat X | | | | 30.00 | |
| Fat XI | | | | | 30.00 |
| Total fat content* | 31.65 | 31.65 | 31.65 | 31.65 | 31.65 |

*Note:
Some of the fat content in the fat composition is from cocoa powder.

After mixing all ingredients except lecithin, vanillin and some of the fat, the rest are mixed on a Teddy mixer with heat jacket to a consistence of marzipan. Every mixture are refined afterward on a three rolls Bühler refiner to an average particle size at 20 micron. All six masses are dry chonced for 3 hours before the remaining fat is added and then followed by a wet chonching for 3 hours. 0.5 hours before chonching is finished, lecithin and flavor are added. The chocolate are filled into an Aasted tempering machine and tempering is optimized for all five chocolate to a well temper chocolate before 100 g chocolate bars are made by depositing the well temper chocolate into preheated moulds and cooled in a Blumen three zones cooling tunnel for 30 minutes. Temperatures are adjusted to 15° C. in zone 1 and 3 and 12° C. in zone 2. The de-molded chocolate tablet are kept at 20° C. for a week and then moved to 25° C. cabinet for isothermal storage.

Every week the tablet is evaluated for visible bloom by a trained panel of experts and when strong visible bloom is evaluated, the number of days are noted down as the shelf life results. A 100 g tablet is sent for analysis. All fat content is extracted (using the method AOAC 920.39(4.5.01)) and analysis for the triglyceride composition are made using the AOCS Ce 5b-89 method. The sum of the asymmetric isomers StStO+PStO/StPO+PPO is analysed. The analysis can be done by any known method by a commercial laboratory. The amount of the asymmetric isomers are measured using an absolute method Table 5 shows the content of the different Sat₂O TAGs found by using the method AOCS Ce 5b-89. The table 5 also shows the total content of the asymmetrical isomers StStO, PStO/StPO, and PPO. The TAG composition is compared with the shelf life of the chocolate tablets based on the recipes from table 4.

TABLE 5

| | Chocolate | | | | |
|---|---|---|---|---|---|
| | VII | VIII | IX | X | XI |
| POP AOCS | 27.6% | 29.7% | 22.6% | 15.0% | *** |
| Ce 5b-89 | | | | | 17.5% |
| POSt AOCS | 25.0% | 24.9% | 30.4% | 37.5% | 31.0% |
| Ce 5b-89 | | | | | |
| StOSt AOCS | 27.0% | 25.1% | 27.1% | 27.0% | 29.6% |
| Ce 5b.89 | | | | | |
| Total Sat₂O | 79.6% | 79.7% | 80.1% | 79.5% | 78.1% |
| TAGs AOCS | | | | | |
| Ce 5b.89 | | | | | |
| Days before | >365 | >365 | >365 | >365 | >365 |
| strong bloom | | | | | |
| at 20° C. | | | | | |
| isothermal | | | | | |
| storage | | | | | |
| Days before | 203 | 175 | 77 | 42 | 91 |
| strong bloom | | | | | |
| at 25° C. | | | | | |
| isothermal | | | | | |
| storage | | | | | |
| StOSt/POSt | 1.08 | 1.01 | 0.89 | 0.72 | 0.95 |
| AOCS | | | | | |
| Ce 5b-89 | | | | | |
| ΣStStO + | 1.6 | 1.7 | 1.5 | <0.5* | <0.5* |
| PStO + | | | | | |
| StPO + PPO | | | | | |

*Below the detection limit.

Chocolate VII, VIII, and IX show a clear correlation between an increasing ratio of StOSt/POSt and increasing bloom stability at 25° C. isotherm storage for a constant content of ΣStStO+PStO+StPO+PPO at around 1.6%, +/−0.1.

Chocolate X and XI show a clear correlation between an increasing ratio of StOSt/POSt and increasing bloom stability at 25° C. isotherm storage for a constant content of FStStO+PStO+StPO+PPO at <0.5%.

The results shows that even though the isomer StStO, PStO/StPO, and PPO have a bloom retarding effect in chocolate it is very important to increase the StOSt/POSt ratio to maximize the total bloom stability at 25° C. isotherm.

### Example 3

It is known that there is both a correlation between increasing St₂O content and increasing bloom stability at 25° C. as well as a more waxy and slow melting profile of the chocolate. Therefore there are a limit of how much St₂O TAGs a chocolate can contain and still maintain a chocolate-like texture and nice melting. To illustrate this connection four chocolates are made and investigated for its melting peak value and end set by analyzing on a Mettler Toledo DSC. Table 6 shows the recipe of the 4 chocolates used for DSC measurements.

TABLE 6

| | |
|---|---|
| All amounts | Chocolate |

| are in wt % | XII | XIII | XIIII | XV |
|---|---|---|---|---|
| Sugar | 48.58 | 48.58 | 48.58 | 48.58 |
| Cocoa powder (11%) | 15.00 | 15.00 | 15.00 | 15.00 |
| Skim milk powder | 6.00 | 6.00 | 6.00 | 6.00 |
| Lecithin | 0.40 | 0.40 | 0.40 | 0.40 |
| Vanillin | 0.02 | 0.02 | 0.02 | 0.02 |
| Fat XII | 30.00 | | | |
| Fat XIII | | 30.00 | | |
| Fat XIIII | | | 30.00 | |
| Fat XV | | | | 30.00 |
| Total fat content* | 31.65 | 31.65 | 31.65 | 31.65 |

*Note:
Some of the fat content in the fat composition is from cocoa powder.

After mixing all ingredients except lecithin, vanillin, and some of the fat, the rest are mixed on a Teddy mixer with heat jacket to a consistence of marcipan. Every mixture are refined afterward on a three rolls Bühler refiner to an average particle size at 20 micron. All four masses are dry chonced for 3 hours before the remaining fat is added and then followed by a wet chonching for 3 hours. 0.5 hours before chonching is finished, lecithin and flavor are added. The chocolate are filled into an Aasted tempering machine and tempering is optimized for all four chocolate to a well temper chocolate before 100 g chocolate bars are made by depositing the well temper chocolate into preheated moulds and cooled in a Blumen three zones cooling tunnel for 30 minutes. Temperatures are adjusted to 15° C. in zone 1 and 3 and 12° C. in zone 2. The de-molded chocolate tablets are kept at 20° C. for a week and then refine on a grater. Table 7 shows the content of the different Sat₂O TAGs found by using the method AOCS Ce 5b-89. The TAG composition is compared with the DSC peak value and the end set of melting curves for the refined four chocolates. 10 mg refined chocolate based on the recipe from table 6 are weighed off in a DSC cup and melted in a Mettler Toledo DSC equipment. The program is as following: 2 minutes isotherm at 20.0° C. follow by a heating rate of 3° C./minutes from 20° C. to 50° C. An average of three analysis is used for calculating the Melting curves peak value and end set. Higher value correlate to higher melting point and slower melting and a more waxy taste when eaten by human being. Chocolate XII is a standard chocolate based on a pure prime press cocoa butter from West Africa. The other three chocolates in table 7, XIII, XIII, and XV, have more StOSt (and its isomer) added as shown in table 7.

TABLE 7

| | Chocolate | | | |
|---|---|---|---|---|
| | XII | | | |
| | Std. chocolate | XIII | XIIII | XV |
| POP AOCS Ce 5b-89 | 15.1% | 16.1% | 15.4% | 15.0% |
| POSt AOCS Ce 5b-89 | 37.9% | 34.0% | 32.4% | 30.0% |
| StOSt AOCS Ce 5b.89 | 27.7% | 30.1% | 31.9% | 34.6% |
| Total Sat₂O TAGs | 80.7% | 80.2% | 79.7% | 79.6% |
| AOCS Ce 5b.89 | | | | |
| DSC Peak value ° C. | 32.7 | 33.6 | 34.1 | 34.5 |
| DSC End Set ° C. | 34.0 | 34.7 | 35.0 | 35.4 |

Table 7 shows the impact of the St₂O content on the DSC peak value and end set for the melting curve of a chocolate. Higher content of St₂O TAGs gives a DSC higher peak value and end set when the chocolate is melted. To keep a “chocolate like” melting behaviour there will be a maximum level of St₂O TAGs which are accepted of most people. This level is defined to be maximum 30% based on the table 7 results and common knowledge from this business. Even better will be maximum 29% or as close to the used cocoa butter as possible.

### Example 4

Example 4 shows that if milk fat is added in amount of from 0 wt % to 10 wt % to a cocoa butter composition then we simply dilute the POSt, POP, and StOSt and their isomers but the StOSt/POSt ratio are almost constant.

If it is a clean CBE system without cocoa butter and we mix up to 10% milk fat in the composition the same trend is seen just with a bit more effect on the StOSt/POSt ratio—but not a significant effect.

Thus, if the amount of added milk fat to the composition is kept relatively low, the bloom stability is considered not to be effected.

TABLE 8

| Sample | 1 | 2 | 3 | 4 | 5 | 6 |
|---|---|---|---|---|---|---|
| Cocoa butter (wt %) | 100 | 95 | 90 | 0 | 0 | 0 |
| CBE (wt %) | 0 | 0 | 0 | 100 | 95 | 90 |
| Milk fat (wt %) | 0 | 5 | 10 | 0 | 5 | 10 |
| POP AOCS Ce 5b-89 | 15.3% | 15.3% | 15.2% | 35.8% | 35.5% | 35.1% |
| POSt AOCS Ce 5b-89 | 38.2% | 37.8% | 37.3% | 10.6% | 10.5% | 10.6% |
| StOSt AOCS Ce 5b-89 | 27.6% | 27.2% | 26.8% | 31.7% | 31.2% | 30.7% |
| stost/post AOCS Ce 5b-89 | 0.72 | 0.72 | 0.72 | 2.99 | 2.97 | 2.90 |

1-15. (canceled)

16. A fat composition comprising triglycerides of which at least 75% is of the type Sat₂O, and wherein, in the fat composition:
a) the content of S12O is 30% or less of the total fat, and
B) the ratio (StOSt+StStO)/(POSt+PStO+StPO) is at least 0.95.

17. A fat composition according to claim 16, wherein between 75% and 85% of the triglycerides are of the type Sat₂O.

18. A fat composition according to claim 16, wherein between 77% and 83% of the triglycerides are of the type Sat₂O.

19. A fat composition according to claim 16, wherein the content of St₂O is 28% or less of the total fat content.

20. A fat composition according to claim 16, wherein the ratio (StOSt+StStO)/(POSt+PStO+StPO) is at least 1.

21. A fat composition according to claim 16, wherein the ratio (StOSt+StStO)/(POSt+PStO+StPO) is between 1 and 3.

22. A fat composition according to claim 16, further comprising milk fat and wherein, in the fat composition, the content of milk fat is 20 wt % or less of the total fat content.

23. A fat composition according to claim 16, wherein the content in % of triglycerides is measured according to the AOCS Ce 5b-89 standard method.

24. A fat composition according to claim 16, wherein the fat composition is a coating compound.

25. A fat composition according to claim 16, wherein the fat composition is a chocolate or chocolate-like fat composition.

26. A fat composition according to claim 16, wherein the fat composition is employed for manufacture of a processed food product for human consumption.

27. A fat composition according to claim 16, wherein the fat composition is employed as an ingredient in a confectionary product.

28. A fat composition according to claim 16, wherein the fat composition is employed as an ingredient in coating compounds for a confectionary product.

29. A fat composition according to claim 16, wherein the fat composition is employed as an ingredient in a chocolate or chocolate-like product.

30. A coating compound, chocolate, or chocolate-like product comprising between 15% and 60% by weight of a fat composition according to claim 16.
